(19) United States
(12) Patent Application Publication
(10) Pub. No.: US 2026/0347183 A1
(43) Pub. Date: Nov. 5, 2026

(54) IODINE RECOVERING METHOD AND SYSTEM

(71) Applicants: SK Innovation Co., Ltd., Seoul (KR); SK ON CO., LTD., Seoul (KR)

(72) Inventors: Hee Du LEE, Daejeon (KR); Soo Kil KANG, Daejeon (KR); Seung Ok LEE, Daejeon (KR); Ho Won LEE, Daejeon (KR); Ju Hwan IM, Daejeon (KR); Jae Hun JEONG, Daejeon (KR)

(21) Appl. No.: 19/647,906

(22) Filed: Apr. 15, 2026

(30) Foreign Application Priority Data
Apr. 30, 2025 (KR) 10-2025-0057756
Sep. 25, 2025 (KR) 10-2025-0139250

(51) Int. Cl. C01B 7/14; B01D 3/00; B01D 53/14; B01D 53/18

(52) U.S. Cl. CPC C01B 7/14; B01D 3/00; B01D 53/1412; B01D 53/1418; B01D 53/18; B01D 2257/2068; B01D 2259/40079

(57) ABSTRACT

An iodine recovery method and system are provided. The iodine recovery method may include supplying, to an absorption tower in a co-current flow, a mixed gas including gaseous iodine (I2) and a gaseous halogenated hydrocarbon, and a liquid organic solvent. The iodine recovery system may include an absorption tower, wherein a mixed gas including gaseous iodine (I₂) and a gaseous halogenated hydrocarbon, and a liquid organic solvent, may be supplied to the absorption tower in a co-current flow.

### CROSS-REFERENCE TO RELATED APPLICATION

This patent application claims priority to and the benefit of Korean Patent Applications No. 10-2025-0057756, filed on Apr. 30, 2025, and No. 10-2025-0139250, filed on Sep. 25, 2025, the entire contents of which are incorporated herein by reference.

### BACKGROUND

### 1. Technical Field

The embodiments of the present disclosure generally relate to an iodine recovery method and an iodine recovery system.

### 2. Description of Related Art

Iodine is a substance that is produced or used in various industrial processes, and methods for recovering iodine have been proposed. For example, a sublimation-deposition method, which sublimates iodine into a gaseous phase and then cools it to recover it in solid form, and a reductive recovery method, which converts iodine into iodide ions (I) using a reducing agent and then recovers it, are known in the art. In the case of the sublimation-deposition method, the solid iodine deposited by the sublimation-deposition process can adhere to the walls of an apparatus or the inner walls of pipes, which may cause partial or complete blockage of the pipes. In addition, in the case of the sublimation-deposition method, if solid iodine accumulates inside the apparatus to a thickness greater than a predetermined level, problems such as reduced heat transfer efficiency, instability of process operation, and difficulty in continuous process operation may occur. The reductive recovery method is a method in which iodine is converted into iodide ions using a reducing agent and then recovered through an electrochemical method or an additional treatment process. However, to ensure the completeness of the reduction reaction, excessive use of the reducing agent may be required, which may increase the generation of by-products and the burden on the water treatment process. In addition, in the case of the reductive recovery method, if iodide ions are regenerated into iodine (I₂), a separate oxidation process is additionally required, which may increase the complexity of the overall process.

### SUMMARY

Embodiments of the present disclosure provide an iodine recovery method with improved reliability and process operability.

Embodiments of the present disclosure provide an iodine recovery system with improved reliability and process operability.

An iodine recovery method according to embodiments of the present disclosure may include supplying, to an absorption tower in a co-current flow, a mixed gas including gaseous iodine (I₂) and a gaseous halogenated hydrocarbon, and a liquid organic solvent.

In an embodiment, the co-current flow may be formed in a direction from an upper portion toward a lower portion of the absorption tower.

In an embodiment, the content of gaseous iodine in the mixed gas may be set to 1% by volume or more.

In an embodiment, the absorption tower may include a first gas inlet through which the mixed gas is supplied, and the temperature of the first gas inlet may be set to 120 °C or higher.

In an embodiment, the absorption tower may include a first liquid inlet through which the organic solvent is supplied, and the temperature of the first liquid inlet may be set to 5 °C to 50 °C lower than a boiling point of the organic solvent.

In an embodiment, a ratio of a mass flow rate of the organic solvent to a mass flow rate of the mixed gas supplied to the absorption tower may be set to 1 or more.

In an embodiment, the temperature inside the absorption tower may be set to 100 °C or lower.

In an embodiment, the iodine recovery method may further include supplying a first discharged liquid discharged from the absorption tower to a column.

In an embodiment, the iodine recovery method may further include supplying a first discharged gas discharged from the absorption tower to a caustic tower.

In an embodiment, the iodine recovery method may further include discharging a second discharged liquid including liquid iodine (I₂) from the column by distillation.

An iodine recovery system according to embodiments of the present disclosure may include an absorption tower, wherein a mixed gas including gaseous iodine (I₂) and a gaseous halogenated hydrocarbon, and a liquid organic solvent, may be supplied to the absorption tower in a co-current flow.

In an embodiment, the absorption tower may include a first gas inlet through which the mixed gas is supplied and a first liquid inlet through which the organic solvent is supplied, at an upper portion thereof, and a first liquid outlet through which a first discharged liquid is discharged and a first gas outlet through which a first discharged gas is discharged, at a lower portion thereof.

In an embodiment, the iodine recovery system may further include a mixed gas supply unit configured to control the content of the gaseous iodine in the mixed gas to 1% by volume or more.

In an embodiment, the iodine recovery system may further include a first temperature control unit configured to control the temperature of the first gas inlet to 120 °C or higher.

In an embodiment, the iodine recovery system may further include a second temperature control unit configured to control the temperature of the first liquid inlet to be 5 °C to 50 °C lower than a boiling point of the organic solvent.

In an embodiment, the iodine recovery system may further include a flow rate control unit configured to control a ratio of a mass flow rate of the organic solvent to a mass flow rate of the mixed gas supplied to the absorption tower to 1 or more.

In an embodiment, the iodine recovery system may further include a third temperature control unit configured to control the temperature inside the absorption tower to 100 °C or lower.

In an embodiment, the iodine recovery system may further include a column, wherein a first discharged liquid discharged from the absorption tower may be supplied to the column.

In an embodiment, the iodine recovery system may further include a caustic tower, wherein the first discharged gas discharged from the absorption tower may be supplied to the caustic tower.

In an embodiment, the iodine recovery system may further include an iodine recovery unit, wherein the iodine recovery unit may be configured to recover a second discharged liquid discharged from the column and including liquid iodine (I₂).

The iodine recovery method according to embodiments of the present disclosure may provide improved reliability and process operability.

The iodine recovery system according to embodiments of the present disclosure may provide improved reliability and process operability.

According to the iodine recovery method and system, the excessive use of a reducing agent is unnecessary, such that subsequent processes required for byproduct removal, filtration, and cleaning may be reduced or eliminated, thereby reducing environmental impact.

In addition, according to the iodine recovery method and system, the number of overall processes may be reduced, which may improve iodine recovery speed and productivity.

### BRIEF DESCRIPTION OF THE DRAWINGS

FIG. 1 is a schematic process flow diagram of an iodine recovery method according to an embodiment of the present disclosure;

FIG. 2 is a schematic process flow diagram of an iodine recovery method according to another embodiment of the present disclosure;

FIG. 3 is a schematic block diagram of an iodine recovery system according to an embodiment of the present disclosure; and

FIG. 4 is a schematic block diagram of an iodine recovery system according to another embodiment of the present disclosure.

### DETAILED DESCRIPTION

Hereinafter, embodiments of the present disclosure will be described in more detail with reference to the accompanying drawings. In this regard, identical reference numerals are used to designate identical components shown in the drawings, and repeated descriptions of the same components will be omitted. The embodiments disclosed in the accompanying drawings are illustrative only, and it should be understood that the embodiments of the present disclosure encompass all modifications, equivalents, and alternatives falling within the spirit and technical scope of the present disclosure.

As used herein, terms such as “on,” “disposed,” and the like include not only direct placement but also cases in which one or more intervening components are interposed.

Terms such as “first,” “second,” “below,” “lower,” “above,” and “upper” are used in a relative sense to distinguish between different components or positions, and do not indicate absolute positions or order.

### Iodine Recovery Method

Hereinafter, embodiments of the present disclosure are further described with reference to specific experimental examples. The examples and comparative examples included in the experimental examples are merely illustrative of the embodiments of the present disclosure and do not limit the scope of the appended claims.

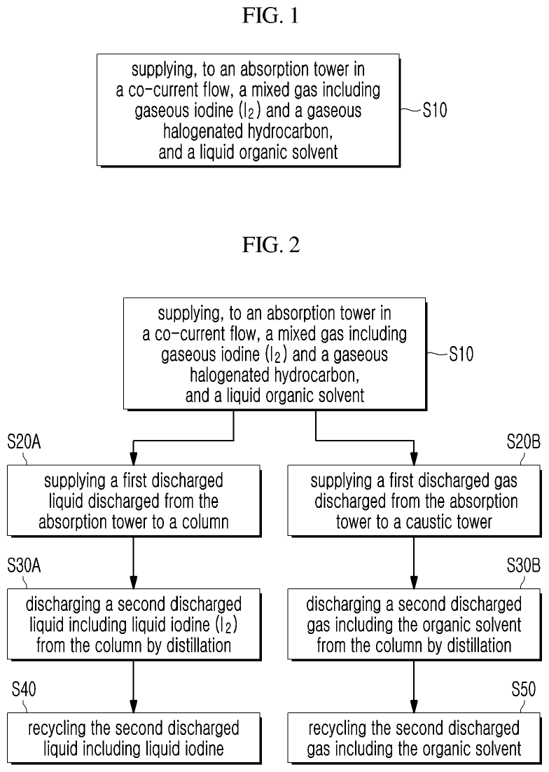

FIG. 1 is a schematic process flow diagram of an iodine recovery method according to an embodiment of the present disclosure.

The iodine recovery method according to an embodiment of the present disclosure may include supplying, to an absorption tower in a co-current flow, a mixed gas including gaseous iodine (I₂) and a gaseous halogenated hydrocarbon, and a liquid organic solvent (operation S10). In operation S10, a mixed gas including gaseous iodine (I₂) and gaseous halogenated hydrocarbon, and an organic solvent in a liquid phase may be supplied to an absorption tower such that the mixed gas and the liquid organic solvent flow in a co-current manner within the absorption tower. For example, the liquid organic solvent and the mixed gas may be introduced into the absorption tower to flow in substantially the same direction.

According to the recovery method, high-temperature gaseous iodine may be prevented from being directly introduced into a relatively large amount of low-temperature organic solvent, such that the gaseous iodine and the organic solvent may not contact each other at a gas inlet of the absorption tower and a surrounding region thereof. Accordingly, in an initial region introduced into the absorption tower, for example, in the vicinity of the gas inlet, the temperature of the gaseous iodine may not decrease abruptly, thereby preventing or reducing precipitation or adhesion of solid iodine at the gas inlet of the absorption tower and the surrounding region thereof.

In an embodiment, the co-current flow may be formed in a direction from an upper portion toward a lower portion of the absorption tower.

If the co-current flow is formed in a direction from the lower portion toward the upper portion of the absorption tower, the organic solvent may accumulate in the lower portion of the absorption tower due to gravity over time, thereby forming a liquid layer. When the mixed gas flows into the liquid layer, a counter-current flow may be formed.

When a counter-current flow is formed, the temperature of the gaseous iodine may decrease abruptly as the gaseous iodine comes contacts a relatively large amount of organic solvent at the gas inlet and a surrounding region thereof. This may cause precipitation and/or adhesion of solid iodine at the gas inlet and the surrounding region thereof.

Therefore, the recovery method according to the embodiments of the present disclosure may effectively suppress or reduce precipitation and adhesion of solid iodine by applying a co-current flow, while preventing localized cooling in a surrounding region of the gas inlet.

In an embodiment, a content of gaseous iodine in the mixed gas may be set to 1% by volume (“vol %”) or more. The content of the gaseous iodine may be, for example, 1 vol % to 50 vol %, or 15 vol % to 20 vol %.

Accordingly, the iodine recovery efficiency may be improved when iodine is recovered in a liquid phase rather than in a gaseous phase.

In an embodiment, the absorption tower may include a first gas inlet through which the mixed gas is supplied, and a temperature of the first gas inlet may be set to 120 °C or higher. The temperature of the first gas inlet may refer to a temperature of a structure defining the first gas inlet and/or a region in the vicinity thereof, and a temperature of the mixed gas supplied through the first gas inlet may be controlled within the above temperature range.

Accordingly, precipitation of iodine at the first gas inlet and/or a surrounding region thereof may be further suppressed.

The temperature of the first gas inlet may be set, for example, to 120 °C to 550 °C.

In an embodiment, the temperature of the first gas inlet may be set to 150 °C to 300 °C.

In an embodiment, the organic solvent may include benzene, toluene, dichloromethane, ethanol, diethyl ether, hexane, cyclohexane, acetone, tetrahydrofuran, benzyl alcohol, xylene, trichloroethylene, phenol, chlorobenzene, dioxane, pyridine, chloroform, carbon tetrachloride, carbon disulfide, butan-2-ol, and/or ethyl acetate.

In an embodiment, the absorption tower may include a first liquid inlet through which the organic solvent is supplied, and a temperature of the first liquid inlet may be set to 5 °C to 50 °C lower than a boiling point of the organic solvent. The temperature of the first liquid inlet may refer to a temperature of a structure defining the first liquid inlet and/or a region in the vicinity thereof, and a temperature of the liquid organic solvent supplied through the first liquid inlet may be controlled within the above temperature range.

Accordingly, vaporization of the organic solvent within the absorption tower may be prevented or suppressed.

In an embodiment, a ratio (organic solvent flow rate/mixed gas flow rate) of a mass flow rate of the organic solvent to a mass flow rate of the mixed gas supplied to the absorption tower may be set to 1 or more. The ratio may be set, for example, to 1 to 10, 1.5 to 5, or 2 to 4.

Accordingly, an amount of gaseous iodine that is discharged without being dissolved in the organic solvent may be effectively reduced, thereby improving iodine recovery efficiency.

In an embodiment, a flow rate of the mixed gas may be set to 0.1 g/s to 10,000 g/s.

In an embodiment, a flow rate of the organic solvent may be set to 0.1 g/s to 100,000 g/s.

The flow rates of the mixed gas and the organic solvent may be selected within the above-described ranges to correspond to laboratory-scale, pilot-scale, or commercial-scale operation, depending on a throughput of an iodine recovery target material, a reactor scale, operational objectives, and the like.

In an embodiment, a residence time of the mixed gas within the absorption tower may be 1 minute to 30 minutes, for example, 1 minute to 20 minutes, 1 minute to 10 minutes, or 2 minutes to 5 minutes. The residence time may be defined, for example, as a time period from when the mixed gas is introduced into the absorption tower to when the mixed gas is discharged from the absorption tower.

In an embodiment, a temperature inside the absorption tower may be maintained at 100 °C or lower. For example, the temperature inside the absorption tower may be maintained in a range of from 10 °C to 60 °C, or from 20 °C to 30 °C.

Accordingly, vaporization of the organic solvent may be prevented, iodine may be effectively dissolved into the organic solvent, and dissolution of the halogenated hydrocarbon may be suppressed or reduced. The halogenated hydrocarbon may be discharged from the absorption tower in a gaseous phase without being dissolved in the organic solvent, or, even if temporarily dissolved in the organic solvent, may be re-vaporized and discharged from the absorption tower in the gaseous phase.

FIG. 2 is a schematic process flow diagram of an iodine recovery method according to another embodiment of the present disclosure.

In an embodiment, the recovery method may further include supplying a first discharged liquid discharged from the absorption tower to a column (operation S20A).

The first discharged liquid may include, for example, liquid iodine (I₂) and a liquid organic solvent.

That is, the first discharged liquid may include an organic solvent in which iodine is dissolved.

In an embodiment, the mixed gas may further include gaseous hydrogen halide.

In an embodiment, the recovery method may further include supplying a first discharged gas discharged from the absorption tower to a caustic tower (operation S20B).

The first discharged gas may include, for example, a gaseous halogenated hydrocarbon and/or a gaseous hydrogen halide.

In an embodiment, the column may be, for example, a distillation column, and the distillation column may be, for example, a stripper.

In an embodiment, the recovery method may further include discharging a second discharged liquid including liquid iodine (I₂) from the column by distillation (operation S30A).

In an embodiment, the recovery method may further include discharging a second discharged gas including the organic solvent from the column by distillation (operation S30B).

In an embodiment, the second discharged gas may include a gaseous organic solvent.

In a non-limiting embodiment, the stripper may be an apparatus for selectively removing an organic solvent, which is a volatile component of the first discharged liquid. For example, the temperature inside the stripper may be set to be equal to or higher than the boiling point of the organic solvent to evaporate the organic solvent.

For example, the second discharged liquid may be discharged from a lower portion of the column. In addition, for example, the second discharged gas may be discharged from an upper portion of the column.

In an embodiment, the recovery method may further include recycling the second discharged liquid including liquid iodine (operation S40).

In an embodiment, the second discharged liquid may include liquid iodine in an amount of 90% by weight (“wt %”) or more, 95 wt % or more, 99 wt % or more, or 99.99 wt % or more based on the total weight of the second discharged liquid. The upper limit is preferably as high as possible and is not particularly limited.

Since the second discharged liquid may be directly used in a recycling process without additional processes such as separation or purification, energy efficiency may be enhanced, and process simplification and operational convenience may be improved.

The second discharged liquid may be provided, for example, to various reaction processes that use iodine as a raw material, thereby effectively recycling the second discharged liquid including liquid iodine.

The reaction process only needs to include iodine as one of the reaction raw materials and is not particularly limited.

In a non-limiting embodiment, the second discharged liquid may be supplied to a reactor. The second discharged liquid may be supplied to the reactor in a liquid state, or the iodine included in the second discharged liquid may be vaporized and supplied in a gaseous phase.

In a non-limiting embodiment, a mixed gas including gaseous iodine (I₂) and a gaseous halogenated hydrocarbon may be discharged from the reactor.

For example, iodine in a liquid state or in a gaseous phase and other reaction raw materials may be mixed, either separately or together, and introduced into the reactor. A high-temperature reaction may then be carried out within the reactor, resulting in a product including a mixed gas including gaseous iodine (I₂) and a gaseous halogenated hydrocarbon. By applying the iodine recovery method described herein, iodine included in the mixed gas may be efficiently recycled over a long period of time while suppressing or reducing damage to apparatuses or equipment caused by precipitation or adhesion of iodine.

In an embodiment, the recovery method may further include recycling the second discharged gas including the organic solvent (operation S50).

For example, the organic solvent may be recovered and supplied to the absorption tower and may be reused to dissolve the gaseous iodine in the absorption tower.

In an embodiment, the second discharged gas may include the organic solvent in an amount of 90 vol % or more, 95 vol % or more, 99 vol % or more, or 99.99 vol % or more.

The second discharged gas may be recovered and/or stored in an organic solvent recovery unit and then transported through a connection line and supplied to the absorption tower or may be transported directly from the column through a connection line and supplied to the absorption tower.

The second discharged gas may be liquefied in the organic solvent recovery unit or in the connection line and supplied to the absorption tower in a liquid state.

In an embodiment, the recovery method may further include supplying a caustic solution to the caustic tower.

In a non-limiting embodiment, the caustic solution may be an aqueous sodium hydroxide solution, an aqueous potassium hydroxide solution, or the like.

In the caustic tower, for example, a hydrogen halide included in the first discharged gas may react with the caustic solution to form an alkali metal halide. The formed alkali metal halide may be discharged from the caustic tower and removed. For example, components other than the alkali metal halide may be discharged from the caustic tower and supplied to a drying tower.

In a non-limiting embodiment, the alkali metal halide may be NaF, NaI, KF, KI, or the like.

The iodine recovery method according to an embodiment may include a circulation loop or structure configured to recycle iodine recovered through the absorption tower and the column. For example, the circulation structure may include resupplying iodine recovered through the absorption tower and the column to a process operation using iodine as a reactant or to an upstream stage of the iodine recovery operation. In addition, the circulation structure may include resupplying an organic solvent recovered through the column to the iodine recovery operation. Accordingly, the recovery method may recycle iodine recovered through the absorption tower and/or the column and/or the organic solvent recovered through the column within the process, thereby minimizing consumption of raw materials and improving process efficiency.

In a non-limiting embodiment, the absorption tower may include a gas inlet through which a gas or a gas mixture is supplied, a liquid inlet through which a liquid such as an organic solvent is supplied, a gas outlet through which gas is discharged, and a liquid outlet through which a discharged liquid in which gas is dissolved is discharged. The absorption tower may be equipped with, for example, packing or trays installed inside a tower body to increase a contact area between gas and liquid, and may further be equipped with a dehydrator or the like, as needed.

In a non-limiting embodiment, the distillation column may include an inlet for supplying a mixture, an outlet for discharging components separated by distillation, and an outlet for discharging residual components excluding the separated components. The distillation column may be equipped with packing or trays installed inside a column body to enhance separation efficiency through contact between vapor and liquid, and may be equipped with a reflux device at an upper portion thereof, as needed.

The caustic tower may, for example, remove acidic components included in a gas by a neutralization reaction using a caustic solution, and may have a structure identical or similar to the structure of the absorption tower described above.

The drying tower may be a device for improving efficiency of subsequent processes or preventing corrosion of equipment, for example, by using adsorption drying or condensation drying.

For example, the absorption tower, the column, the caustic tower, the drying tower, the reactor, and the like may be connected to each other by connection lines, and apparatuses and equipment additionally used for recycling may also be connected via the connection lines.

For example, the absorption tower, the column, the caustic tower, the drying tower, the reactor, and the like may each include one or more inlets and one or more outlets, through which a gaseous fluid or a liquid fluid may be supplied or discharged.

In a non-limiting embodiment, the connection line may be pipes, tubes, or the like, and may be formed of stainless steel, carbon steel, or various alloys.

### Iodine Recovery System

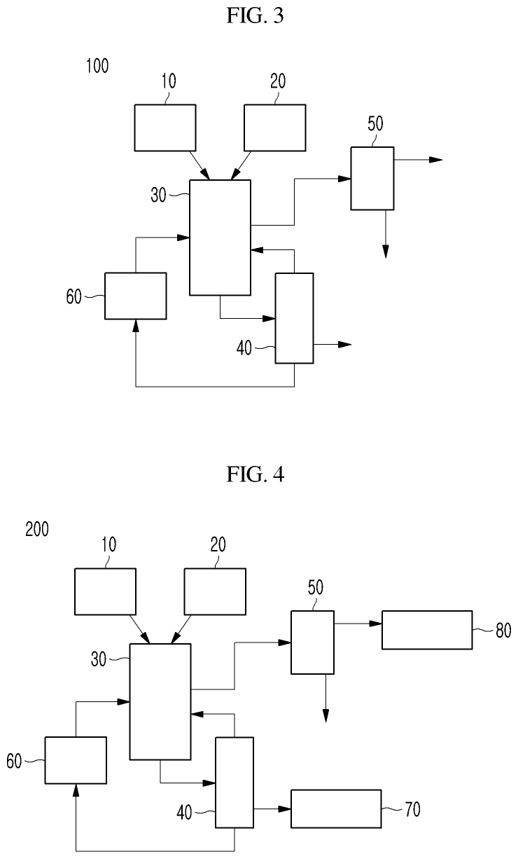

FIG. 3 is a schematic block diagram of an iodine recovery system 100 according to an embodiment of the present disclosure. The iodine recovery method described above may be carried out by the iodine recovery system 100, and descriptions of each component of the iodine recovery system 100 may refer to the foregoing descriptions of corresponding components.

The iodine recovery system 100 according to an embodiment of the present disclosure includes an absorption tower 30, and is configured to supply, to the absorption tower 30 in a co-current flow, a mixed gas including gaseous iodine (I₂) and a gaseous halogenated hydrocarbon, and a liquid organic solvent. That is, the absorption tower 30 is configured to receive, in a co-current flow, the mixed gas and the liquid organic solvent. The mixed gas includes gaseous iodine (I₂) and gaseous halogenated hydrocarbon.

According to the iodine recovery system 100, high-temperature gaseous iodine may be prevented from directly flowing into a relatively large amount of low-temperature organic solvent, such that the gaseous iodine and the organic solvent may not contact each other at a gas inlet of the absorption tower 30 and a surrounding region thereof. Accordingly, the temperature of the gaseous iodine supplied into the absorption tower 30 may not decrease abruptly, thereby preventing or reducing precipitation or adhesion of solid iodine at the gas inlet of the absorption tower 30 and the surrounding region thereof.

In an embodiment, the absorption tower 30 may include, at an upper portion thereof, a first gas inlet through which the mixed gas is supplied and a first liquid inlet through which the organic solvent is supplied, and at a lower portion thereof, a first liquid outlet through which a first discharged liquid is discharged from the absorption tower 30, and a first gas outlet through which the first discharged gas is discharged.

Accordingly, the co-current flow may be formed in a direction from the upper portion toward the lower portion of the absorption tower 30.

The upper portion and the lower portion of the absorption tower 30 may refer to an upper region and a lower region required for forming the co-current flow. For example, the upper portion of the absorption tower 30 may refer to an uppermost end and an adjacent region thereof, and the lower portion of the absorption tower 30 may refer to a lowermost end and an adjacent region thereof.

For example, based on the total height of the absorption tower 30, the first gas inlet may be positioned at the uppermost end, or on a side surface within a height range of 15% or less of the total height measured from the uppermost end.

For example, based on the total height of the absorption tower 30, the first liquid inlet may be positioned at the uppermost end, or on a side surface within a height range of 15% or less of the total height measured from the uppermost end.

For example, based on the total height of the absorption tower 30, the first liquid outlet may be positioned at the lowermost end, or on a side surface within a height range of 15% or less of the total height measured from the lowermost end.

For example, based on the total height of the absorption tower 30, the first gas outlet may be positioned at the lowermost end, or on a side surface within a height range of 15% or less of the total height measured from the lowermost end.

In an embodiment, the recovery system 100 may further include a mixed gas supply unit configured to control a content of gaseous iodine in the mixed gas to be 1 vol % or more. That is, the recovery system 100 may further include the mixed gas supply unit configured to control the content of the gaseous iodine in the mixed gas to be 1 vol % or more.

The content of the gaseous iodine in the mixed gas may be 1 vol % or more, for example, 1 vol % to 50 vol %, or 15 vol % to 20 vol %.

Accordingly, the recovery efficiency may increase when iodine is recovered in a liquid state rather than in a gaseous phase.

In a non-limiting embodiment, the mixed gas supply unit may include, for example, a flow control valve configured to adjust a flow rate of an iodine-containing source gas, a flow controller configured to control an input amount of a remaining gas, or a sensor-based control device configured to detect a mixing ratio in real time and perform feedback control.

In an embodiment, the recovery system 100 may further include a first temperature control unit configured to control a temperature of the first gas inlet to be 120 °C or higher. That is, the recovery system 100 may further include the first temperature control unit configured to control the temperature of the first gas inlet to be 120 °C or higher.

Accordingly, precipitation of iodine at the first gas inlet and/or in a surrounding region thereof may be further suppressed.

A temperature of the first gas inlet may be controlled, for example, within a range of 120 °C to 550 °C, or 150 °C to 300 °C.

In an embodiment, the recovery system 100 may further include a second temperature control unit configured to control a temperature of the first liquid inlet to be 5 °C to 50 °C lower than a boiling point of the organic solvent. That is, the recovery system 100 may further include the second temperature control unit configured to control the temperature of the first liquid inlet to be 5 °C to 50 °C lower than the boiling point of the organic solvent. Accordingly, vaporization of the organic solvent within the absorption tower 30 may be prevented or suppressed.

In an embodiment, the recovery system 100 may further include a third temperature control unit configured to control a temperature inside the absorption tower 30 to be 100 °C or lower. That is, the recovery system 100 may further include the third temperature control unit configured to control the temperature inside the absorption tower to be 30 to 100 °C or lower. The temperature inside the absorption tower 30 may be controlled, for example, within a range of 10 °C to 60 °C or 20 °C to 30 °C.

Accordingly, vaporization of the organic solvent may be prevented, iodine may be effectively dissolved into the organic solvent, and dissolution of the halogenated hydrocarbon may be suppressed or reduced. The halogenated hydrocarbon may be discharged from the absorption tower 30 in a gaseous phase without being dissolved in the organic solvent, or, even if temporarily dissolved in the organic solvent, may be re-vaporized and discharged from the absorption tower 30 in the gaseous phase.

In non-limiting embodiments, the first to third temperature control units may include a heater, a heating wire, a thermoblock, a jacket-type heating means, and may also include a temperature sensor such as a thermocouple or a resistance temperature detector (RTD), as needed. The first to third temperature control units may be installed, for example, on an outer circumferential surface or inside each apparatus.

In an embodiment, the recovery system 100 may further include a flow control unit configured to control a ratio of a mass flow rate of the organic solvent to a mass flow rate of the mixed gas supplied to the absorption tower 30 to be 1 or more. That is, the recovery system 100 may further include the flow control unit configured to control the ratio of the mass flow rate of the organic solvent to the mass flow rate of the mixed gas supplied to the absorption tower 30 to be 1 or more. The ratio may be controlled, for example, within a range of 1 to 10, 1.5 to 5, or 2 to 4. Accordingly, an amount of the gaseous iodine that is discharged without being dissolved in the organic solvent may be effectively reduced, thereby improving the recovery efficiency of iodine.

In non-limiting embodiments, the flow control unit may include a mass flow meter, a volumetric flow meter, a pressure-regulating flow controller, a flow control valve, or the like.

In an embodiment, the flow rate of the mixed gas may be set to 0.1 g/s to 10,000 g/s.

In an embodiment, the flow rate of the organic solvent may be set to 0.1 g/s to 100,000 g/s.

In an embodiment, the ratio of the mass flow rate of the organic solvent to the mass flow rate of the mixed gas supplied into the absorption tower 30 may be 1 or more, for example, 1 to 10, 1.5 to 5, or 2 to 4.

Accordingly, an amount of gaseous iodine that is discharged without being dissolved in the organic solvent may be effectively reduced.

In an embodiment, a residence time of the mixed gas within the absorption tower 30 may be controlled to be within a range of 1 minute to 30 minutes, 1 minute to 20 minutes, 1 minute to 10 minutes, or 2 minutes to 5 minutes. The residence time may be defined, for example, as a time period from when the mixed gas is introduced into the absorption tower 30 until the mixed gas is discharged from the absorption tower 30.

In an embodiment, the recovery system 100 may further include a column 40, and may supply a first discharged liquid discharged from the absorption tower 30 to the column 40. The first discharged liquid may include, for example, liquid iodine (I₂) and liquid organic solvent. That is, the first discharged liquid may include organic solvent in which iodine is dissolved.

In an embodiment, the mixed gas may further include gaseous hydrogen halide.

In an embodiment, the recovery system 100 may further include a caustic tower 50, and may supply a first discharged gas discharged from the absorption tower 30 to the caustic tower 50.

The first discharged gas may include, for example, gaseous halogenated hydrocarbons and/or a gaseous hydrogen halide.

FIG. 4 is a schematic block diagram of an iodine recovery system 200 according to another embodiment of the present disclosure.

In an embodiment, the recovery system 200 may further include an iodine recovery unit 70, and the iodine recovery unit 70 may recover a second discharged liquid including liquid iodine (I₂) discharged from the column 40. That is, the iodine recovery unit 70 may be configured to recover the second discharged liquid including liquid iodine (I₂) discharged from the column 40.

In an embodiment, the second discharged liquid may include liquid iodine in an amount of 90 wt % or more, 95 wt % or more, 99 wt % or more, or 99.99 wt % or more based on the total weight of the second discharged liquid.

In an embodiment, the recovery system 200 may further include a reactor 60, and the second discharged liquid may be supplied to the reactor 60.

For example, iodine in a liquid state or in a gaseous phase and other reaction raw materials may be mixed, either separately or together, and introduced into the reactor 60. A high-temperature reaction may then be carried out within the reactor 60, resulting in a product including a mixed gas including gaseous iodine (I₂) and a gaseous halogenated hydrocarbon. By applying the iodine recovery system 200, iodine included in the mixed gas may be efficiently recycled over a long period of time while suppressing or reducing damage to apparatuses or equipment caused by precipitation or adhesion of iodine.

The other reactant materials may be sufficient as long as they are capable of producing a product including the mixed gas, and their types are not particularly limited.

In an embodiment, the column 40 may be, for example, a distillation column, and the distillation column may be, for example, a stripper.

In an embodiment, the recovery system 200 may further include an organic solvent recovery unit or a connection line that connects the column 40 and the absorption tower 30, and the second discharged gas discharged from the column 40 and including the organic solvent may be supplied to the organic solvent recovery unit or the connection line.

In an embodiment, the recovery system 200 may further include a connection line that connects the column 40 and the absorption tower 30, and the second discharged gas may be supplied to the absorption tower 30 through the connection line. In this case, the second discharged gas may be liquefied within the connection line and supplied to the absorption tower 30 in a liquid state. For example, a gaseous organic solvent may be converted into a liquid organic solvent within the connection line, and the liquid organic solvent may be supplied to the absorption tower 30.

For example, the temperature inside the connection line that connects the column 40 and the absorption tower 30 may be set to be lower than a boiling point of the organic solvent.

For example, the second discharged liquid may be discharged from a lower portion of the column 40. In addition, for example, the second discharged gas may be discharged from an upper portion of the column 40.

The second discharged gas may be recovered and/or stored in an organic solvent recovery unit and then transported through a connection line and supplied to the absorption tower 30, or may be transported directly from the column 40 through a connection line and supplied to the absorption tower 30.

The second discharged gas may be liquefied in the organic solvent recovery unit or in the connection line and supplied to the absorption tower 30 in a liquid state.

Accordingly, the recovered organic solvent may be reused to dissolve the gaseous iodine in the absorption tower 30.

In an embodiment, the recovery system 200 may further include a caustic solution supply unit configured to supply a caustic solution to the caustic tower 50. Descriptions of the caustic solution refer to the foregoing descriptions.

In an embodiment, the recovery system 200 may further include a drying tower 80 connected to the caustic tower 50. Descriptions of the caustic tower 50 and the drying tower 80 refer to the foregoing descriptions.

The iodine recovery system 200 according to an embodiment may have an overall circulation structure configured to recycle the iodine recovered through the absorption tower 30 and the column 40, and/or to recycle the organic solvent recovered through the column 40, thereby minimizing consumption of raw materials and enhancing process efficiency.

In an embodiment, the recovery system 200 may further include a first supply unit 10 (hereinafter, also referred to as a “mixed gas supply unit”) configured to supply a mixed gas including, for example, gaseous iodine (I₂) and a gaseous halogenated hydrocarbon.

If the mixed gas is supplied from the reactor 60, the first supply unit 10 may be omitted.

For example, the absorption tower 30, the column 40, the iodine recovery unit 70, the caustic tower 50, the drying tower 80, the reactor 60, and the like may be connected to each other by connection lines, and apparatuses and equipment additionally used for recycling may also be connected via the connection lines.

For example, the absorption tower 30, the column 40, the iodine recovery unit 70, the caustic tower 50, the drying tower 80, the reactor 60, and the like may include one or more inlets and one or more outlets, through which a gaseous fluid or a liquid fluid may be supplied or discharged.

In a non-limiting embodiment, the connection line may be pipes, tubes, or the like, and may be formed of stainless steel, carbon steel, or various alloys.

In an embodiment, the recovery system 200 may further include a second supply unit 20 configured to supply a liquid organic solvent. If the liquid organic solvent is supplied through a connection line that connects the absorption tower 30 and the column 40, the second supply unit 20 may be omitted.

In an embodiment, a caustic solution may be further supplied to the caustic tower 50. In a non-limiting embodiment, the caustic solution may be an aqueous sodium hydroxide solution, and descriptions of the caustic solution refer to the foregoing descriptions.

As used herein, the term “unit” refers to a device or apparatus having a specific structure and is not intended to be interpreted as a means-plus-function element.

For example, a “supply unit” may include a supplier (e.g., a supply device), a pump, a valve, a flow controller, a pipe, or a combination thereof, and may be configured to supply a fluid to a target location.

A “temperature control unit” may include a temperature controller, a heater, a cooler, a heat exchanger, or a combination thereof, and may be configured to control a temperature of a fluid or a system.

A “flow control unit” may include a flow controller, a valve, a mass flow controller (MFC), or a combination thereof, and may be configured to regulate a flow rate of a fluid.

An “iodine recovery unit” may include an absorption tower, a column, a reactor, a separator, a storage tank, or a combination thereof, and may be configured to recover and optionally store iodine from a fluid stream.

As used herein, the term “adhesion” refers to attachment of or retention of a material onto a surface, and encompasses various surface attachment phenomena, including, but not limited to, physical adhesion and adsorption (e.g., physisorption and/or chemisorption).

Hereinafter, embodiments of the present disclosure will be additionally described with reference to specific experimental examples. However, the examples and comparative examples included in the experimental examples are merely provided to illustrate the embodiments of the present disclosure and should not be construed as limiting the scope of the appended claims. Furthermore, the embodiments may be combined to form additional embodiments.

### EXAMPLES AND COMPARATIVE EXAMPLES

### Example 1

A system including: a first supply unit for supplying a mixed gas including gaseous iodine and a halogenated hydrocarbon; a second supply unit for supplying liquid toluene; an absorption tower respectively connected to the first supply unit and the second supply unit and into which the mixed gas and the liquid toluene are injected; a column connected to the absorption tower, an iodine recovery unit connected to the column; a caustic tower connected to the absorption tower; and connection lines that connect the foregoing components was designed, and an iodine recovery method was performed using the system. In this regard, the connection sequence refers to the corresponding configuration illustrated in FIGS. 3 and 4. Specifically, a second discharged gas, which includes an organic solvent discharged from the column was recycled to the absorption tower through the connection line.

The specific process conditions were as follows.
Absorption tower structure: A first gas inlet through which the mixed gas is supplied and a first liquid inlet through which the organic solvent is supplied are both formed at an upper portion of the absorption tower.
Mixed gas composition: 1 vol % of gaseous iodine, 50 vol % of a halogenated hydrocarbon, 40 vol % of hydrogen halide, and 9 vol % of N₂ as an inert gas.
Temperature of the first gas inlet through which the mixed gas is supplied: 120 °C.
Supply flow rate of the mixed gas: 1 g/s.
Temperature of the first liquid inlet through which toluene is supplied: 100 °C.
Supply flow rate of toluene: 10 g/s.
Internal temperature of the absorption tower: 100 °C.

### Example 2

A system was designed in the same manner as in Example 1, except that the mixed gas composition was changed as follows.
Mixed gas composition: 3 vol % of gaseous iodine, 50 vol % of a halogenated hydrocarbon, 40 vol % of hydrogen halide, and 7 vol % of N₂ as an inert gas.

### Example 3

A system was designed in the same manner as in Example 1, except that the temperature of the first gas inlet was changed as follows:
Temperature of the first gas inlet through which the mixed gas is supplied: 110 °C.

### Example 4

A system was designed in the same manner as in Example 1, except that the temperature inside the absorption tower was changed as follows:
Internal temperature of the absorption tower: 110 °C.

### Example 5

A system was designed in the same manner as in Example 1, except that the temperature of the first liquid inlet through which toluene is supplied was changed as follows:
Temperature of the first liquid inlet through which toluene is supplied: 110 °C.

### Comparative Example 1

A system was designed in the same manner as in Example 1, except that the structure of the absorption tower was changed as follows:
Absorption tower structure: A first gas inlet through which the mixed gas is supplied is formed at a lower portion of the absorption tower, and a first liquid inlet through which the organic solvent is supplied is formed at an upper portion of the absorption tower.

### Comparative Example 2

A system was designed in the same manner as in Example 1, except that the structure of the absorption tower was changed as follows:
Absorption tower structure: A first gas inlet through which the mixed gas is supplied and a first liquid inlet through which the organic solvent is supplied are both formed at a lower portion of the absorption tower.

### Experimental Example

### Experimental Example 1: Evaluation of Iodine Precipitation/Deposition

After each system was continuously operated for 500 hours, the presence or absence of iodine precipitation and/or adhesion (including adsorption) at the first gas inlet and a surrounding region thereof was visually observed to determine whether iodine precipitation or adhesion occurred. When solid iodine was precipitated and/or adsorbed, the result was indicated by a circle (∘), and when no precipitation or adhesion was observed, the result was indicated by an x (x).

The results are shown in Table 1 below.

### Experimental Example 2: Iodine Recovery Rate

Each system was operated continuously for 500 hours.

The total mass of gaseous iodine supplied to the absorption tower for 500 hours was calculated based on the flow rate of the mixed gas measured using a flow meter and the operating time, and was converted into a mass unit.

The total mass of liquid iodine recovered from the iodine recovery unit was measured using an electronic balance.

Based on the same mass unit, the iodine recovery rate was calculated as a percentage obtained by dividing the total mass of liquid iodine recovered by the total mass of gaseous iodine supplied.

The results are shown in Table 1 below.

TABLE 1

| | Occurrence of iodine precipitation | Iodine recovery rate |
|---|---|---|
| | or adhesion | (%) |
| Example 1 | x | 98 |
| Example 2 | x | 99 |
| Example 3 | x | 87 |
| Example 4 | x | 92 |
| Example 5 | x | 82 |
| Comparative | ∘ | 79 |
| Example 1 | | |
| Comparative | ∘ | 72 |
| Example 2 | | |

According to the iodine recovery methods and systems of the examples, no iodine was observed to precipitate or adhere after 500 hours of continuous operation, and the iodine recovery rate was markedly improved. In addition, in Examples 1 to 4, in which the temperature of the first liquid inlet was set to 5 °C to 50 °C lower than the boiling point of the organic solvent, for example, about 10 °C lower, the iodine recovery rate was further improved compared to Example 5, in which the temperature was set to be substantially identical to the boiling point of the organic solvent.

Conversely, in the iodine recovery methods and systems according to Comparative Examples 1 and 2, iodine was visually confirmed to precipitate in a solid form during operation. Consequently, during long-term operation, the precipitates accumulated in the pipe and inside the absorption tower, thereby partially clogging flow paths. This led to an increase in iodine loss, resulting in a decrease in recovery efficiency, and further caused deterioration in the overall stability of the system.

What is claimed is:

1. An iodine recovery method comprising supplying, to an absorption tower in a co-current flow, a mixed gas including gaseous iodine (I₂) and a gaseous halogenated hydrocarbon, and a liquid organic solvent.

2. The iodine recovery method according to claim 1, wherein the co-current flow is formed in a direction from an upper portion toward a lower portion of the absorption tower.

3. The iodine recovery method according to claim 1, wherein a content of gaseous iodine in the mixed gas is 1% by volume or more.

4. The iodine recovery method according to claim 1, wherein the absorption tower comprises a first gas inlet through which the mixed gas is supplied, and a temperature of the first gas inlet is set to 120 °C or higher.

5. The iodine recovery method according to claim 1, wherein the absorption tower comprises a first liquid inlet through which the organic solvent is supplied, and a temperature of the first liquid inlet is set to 5 °C to 50 °C lower than a boiling point of the organic solvent.

6. The iodine recovery method according to claim 1, wherein a ratio of a mass flow rate of the organic solvent to a mass flow rate of the mixed gas supplied to the absorption tower is set to 1 or more.

7. The iodine recovery method according to claim 1, wherein a temperature inside the absorption tower is set to 100 °C or lower.

8. The iodine recovery method according to claim 1, further comprising supplying a first discharged liquid discharged from the absorption tower to a column.

9. The iodine recovery method according to claim 1, further comprising supplying a first discharged gas discharged from the absorption tower to a caustic tower.

10. The iodine recovery method according to claim 8, further comprising discharging a second discharged liquid including liquid iodine (I₂) from the column by distillation.

11. An iodine recovery system comprising an absorption tower,
wherein a mixed gas including gaseous iodine (I₂) and a gaseous halogenated hydrocarbon, and a liquid organic solvent, are supplied to the absorption tower in a co-current flow.

12. The iodine recovery system according to claim 11, wherein the absorption tower comprises: a first gas inlet through which the mixed gas is supplied and a first liquid inlet through which the organic solvent is supplied, at an upper portion thereof, and
a first liquid outlet through which a first discharged liquid is discharged and a first gas outlet through which a first discharged gas is discharged, at a lower portion thereof.

13. The iodine recovery system according to claim 11, further comprising a mixed gas supply unit configured to control a content of the gaseous iodine in the mixed gas to 1% by volume or more.

14. The iodine recovery system according to claim 12, further comprising a first temperature control unit configured to control a temperature of the first gas inlet to 120 °C or higher.

15. The iodine recovery system according to claim 12, further comprising a second temperature control unit configured to control a temperature of the first liquid inlet to be 5 °C to 50 °C lower than a boiling point of the organic solvent.

16. The iodine recovery system according to claim 11, further comprising a flow rate control unit configured to control a ratio of a flow rate of the organic solvent to a flow rate of the mixed gas supplied to the absorption tower to 1 or more.

17. The iodine recovery system according to claim 11, further comprising a third temperature control unit configured to control a temperature inside the absorption tower to 100 °C or lower.

18. The iodine recovery system according to claim 11, further comprising a column,
wherein a first discharged liquid discharged from the absorption tower is supplied to the column.

19. The iodine recovery system according to claim 11, further comprising a caustic tower,
wherein the first discharged gas discharged from the absorption tower is supplied to the caustic tower.

20. The iodine recovery system according to claim 18, further comprising an iodine recovery unit,
wherein the iodine recovery unit is configured to recover a second discharged liquid discharged from the column and including liquid iodine (I₂).
